(19) United States
(12) Patent Application Publication
(10) Pub. No.: US 2018/0218111 A1
(43) Pub. Date: Aug. 2, 2018

(54) Studying Molecular Interaction via Enhanced Molecular Dynamics Simulations

(71) Applicant: Fondazion Istituto Italiano di Tecnologia, Genova (IT)

(72) Inventors: Walter Rocchia, Genova (IT); Andrea Cavalli, San Lazzaro Di Savena (Bologna) (IT)

(21) Appl. No.: 15/503,403

(22) PCT Filed: Aug. 7, 2015
(86) PCT No.: PCT/IB2015/056017

§ 371 Date: Feb. 13, 2017

Related U.S. Application Data
(60) Provisional application No. 62/036,589, filed on Aug. 12, 2014.

(30) Foreign Application Priority Data
Jan. 15, 2015 (IT) TO2015A000037

(51) Int. Cl. G06F 19/16; G06F 17/11

(52) U.S. Cl. CPC G06F 19/16; G06F 2217/16; G06F 17/11

(57) ABSTRACT

A method is disclosed for enhancing the simulation of the interaction between at least a first and a second molecular system, the interaction resulting from actual attraction and repulsion forces between the at least a first and a second molecular system. The method comprises applying an additional virtual electrostatic force between the at least a first and a second molecular system, which force has a functional form of the type of a modulated electrostatic interaction.

The present invention generally relates to studying molecular interactions and more specifically to a method for enhancing the simulation of the interaction between at least a first and a second molecular system, according to the preamble of claim 1.

Dynamical investigations of molecules binding to biological targets are gaining an increasing interest within the drug discovery, the biophysical, and the chemical communities. These investigations are usually carried out within the molecular dynamics (MD) framework, and several notable examples have recently appeared in the literature either using unbiased or biased MD approaches.

Unbiased MD simulations, referred also to as plain MD, have been run in the microsecond timeframe to study spontaneously the recognition and binding of small organic molecules to biological targets of pharmacological interest. In this context, two breakthrough studies should be mentioned carried out by Shaw and coworkers (Y. Shan, E. T. Kim, M. P. Eastwood, R. O. Dror, M. A. Seeliger, D. E. Shaw, JACS, 133, 9181-9183, (2011)) and De Fabritiis and coworkers (I. Buch, T. Giorgino, G. De Fabritiis, PNAS, 108, 10184-9, (2011)), who have observed, running several microseconds of MD simulations, several binding events that also allowed them to provide estimates of thermodynamic and kinetic entities.

In parallel, several different approaches based on biased MD have been reported in the literature that allow running much shorter simulations identifying binding trajectories and providing qualitative or semi-quantitative estimations of binding free energy and kinetics. These approaches fall in the class of so called enhanced sampling methods, and have been applied to protein-ligand binding and, more in general, to the simulation of rare events.

As an example, metadynamics has played a central role in studying protein-ligand binding, and it has been applied to a variety of targets of pharmacological interest. In addition, steered-MD has also been widely applied in this context, providing in some cases good correlations between unbinding rupture forces and protein-ligand binding affinities.

However, in other examples, steered-MD has failed to provide direct correlations between forces and inhibition constants. In a very recent study by Procacci and coworkers, the Hamiltonian Replica Exchange approach was successfully applied to undocking studies. If compared to other enhanced sampling methodologies, this approach has the advantage to be much less dependent on the choice of a predefined reaction coordinate. Notably, the need to identify a good approximation of the reaction coordinate in enhanced sampling simulations of rare events can be considered one of the major drawbacks of this kind of approaches.

Finally, and very recently, Moro and coworkers have faced the issue of fast MD-based docking simulations developing an approach named supervised MD, which allows docking via MD in the nanosecond timeframe in a supervised manner.

In this scenario, it clearly emerges that protein-ligand binding via MD can nowadays be simulated at two different levels: i) running extensive, microsecond-long unbiased MD-simulations; ii) employing enhanced sampling approaches such as metadynamics, steered-MD, and other related methodologies, where one or more collective variables, approximating the reaction coordinate, must be a priori defined to increase the chances of generating plausible (un)binding trajectories and to avoid missing the sampling of slow degrees of freedom.

Despite being very promising, all these approaches suffer from two major types of limitations: i) being time- and CPU-demanding, well-above the drug discovery requirements, especially for unbiased MD approaches; ii) requiring, for most of enhanced sampling and biased approaches, the identification of proper collective variables, a quite hard task that up to now has proved to be extremely user- and system-dependent.

In particular, the efficient and accurate protein-ligand complex determination using computational methods is still a challenging task.

One of the most widely used techniques used to identify the right conformation corresponding to the bimolecular complex is docking.

Two factors strongly contribute to the failure of docking methods to predict accurately the binding mode: the insufficient incorporation of protein flexibility coupled to ligand binding and the neglected dynamics of the protein-ligand complex in current scoring schemes. In most instances, protein flexibility is underrepresented in computer-aided drug design due to uncertainties on how it should be accurately modeled as well as the computational cost associated with attempting to incorporate flexibility in the calculations.

The objective of the present invention is therefore to provide a solution to the problems disclosed above, avoiding the drawbacks of the prior art.

The above objective is achieved according to the present invention by a method for enhancing the simulation of the interaction between at least a first and a second molecular system, having the features defined in the appended claim 1.

Specific embodiments are the subject of the dependent claims, whose content is to be considered as an integral part of the present description.

In summary, the present invention is based on the fact that it is widely recognized that electrostatic interactions play a pivotal role in protein-ligand recognition and binding and, more in general, in bimolecular interaction, being relevant at both long and short ranges. Actually, long-range electrostatic interaction may increase the time the two binding partners stay in close vicinity, allowing the time for them to reach the best conformation for binding. On the other side, short-range electrostatics provides specificity and increases the strength of the interaction once it is formed.

The present invention proposes a novel enhanced sampling approach toward a more effective exploitation of MD in the simulation of rare events such as molecular docking and, more in general, molecular interaction. The basic idea stems from the observation that electrostatics driven interactions are among the easier to simulate since they usually occur in a shorter timescale than the others. Therefore, the “natural” behavior of electrostatic interaction is exploited in bimolecular recognition, amplifying, or even inserting, electrostatic-like attractions between the atoms of the two interacting partners, which, in the cases most frequently considered here, are a binding pocket and a ligand. In this case, the knowledge required a priori is simply a list of residues that compose the binding pocket, which not necessarily needs to contain only the residues that would natively make direct interaction with the ligand. This knowledge is usually available, especially in the industrial setting before starting any docking or structure-based study.

A novel enhanced sampling method is disclosed, based on the combination of an electrostatics-inspired collective variable and an adaptive behavior, that can be adopted to accelerate a number of relevant physical phenomena that can be classified as rare events. This technique is used to implement a flexible docking method performed in explicit solvent. This allows to enhance the ligand-receptor recognition processes in a protocol that includes full flexibility of the binding partners. The efficiency of the MD-Docking method has been here evaluated on two receptor-ligand systems and one protein-peptide complex. The same collective variable has also been applied to assess the energetic favorableness of water molecule positions in protein binding sites in an accelerated protocol. Results of the different applications and relevance in the drug discovery field are briefly discussed.

The inventive approach consists of a combination of a new collective variable and an adaptive protocol. This variable induces a, possibly modulated, electrostatic attraction (or repulsion) between two user-defined sets of atoms (e.g. those of the binding pocket and of the ligand).

This approach has been systematically applied to a wide variety of protein-ligand complexes of pharmacological interest, encompassing hydrolases, kinases, proteases, in a few protein-protein interaction cases and in an interesting class of problems where the hydration role in protein-ligand binding was studied.

The generality of the approach allows its application to any kind of molecular interaction, including those involving nucleic acids, which are not explicitly covered here. The inventors were able to obtain, in roughly one over 10 replicas of MD simulations long a few ns each, binding poses with a root-mean-square-deviation (RMSD) below 2 Å with respect to the crystallographic ones. This kind of performance was obtained in all the simulated systems.

The methodology according to the invention could represent quite an innovation in the field of molecular docking and binding estimation, allowing a systematic and efficient exploitation of MD in studying processes such as protein-ligand recognition and binding.

These and further features and advantages of the invention will become apparent from the following detailed description, given by way of non-limiting example, of a preferred embodiment thereof. Reference is made to the accompanying drawings, in which:

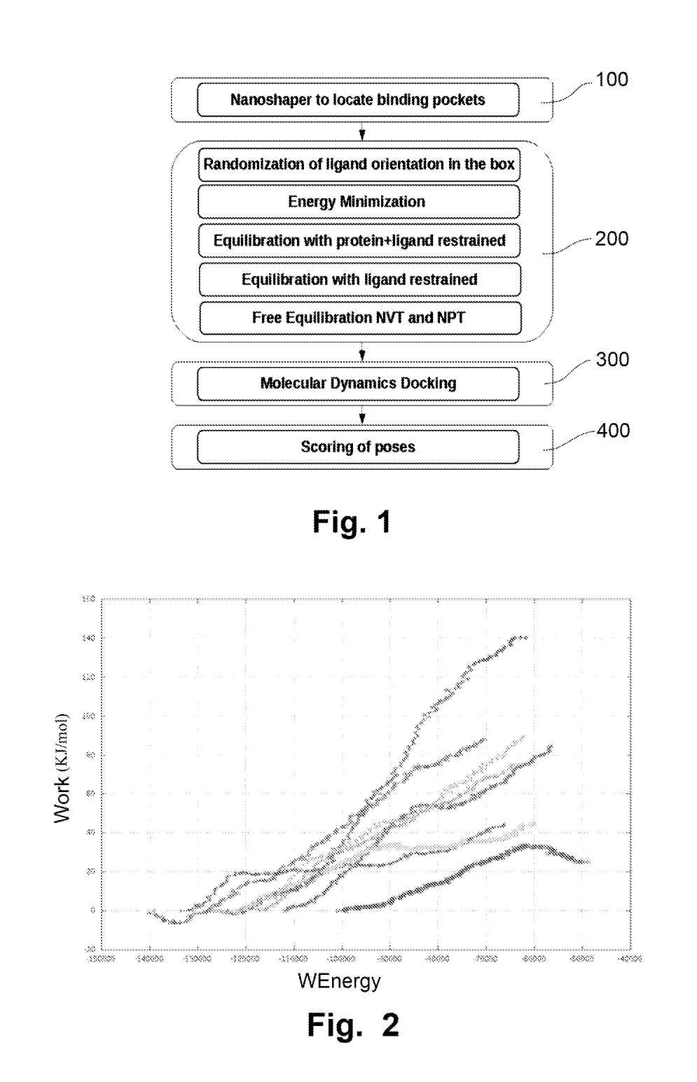

FIG. 1 is a flow chart of the general MD-Dock protocol;

FIG. 2 shows extraction work profiles from different putative binding poses obtained from different MD-dock replicas in the case of the AChE-donepezil complex, where the profiles reaching the 3 highest values correspond to the best pose (RMSD<=2.5 A from the crystal); and

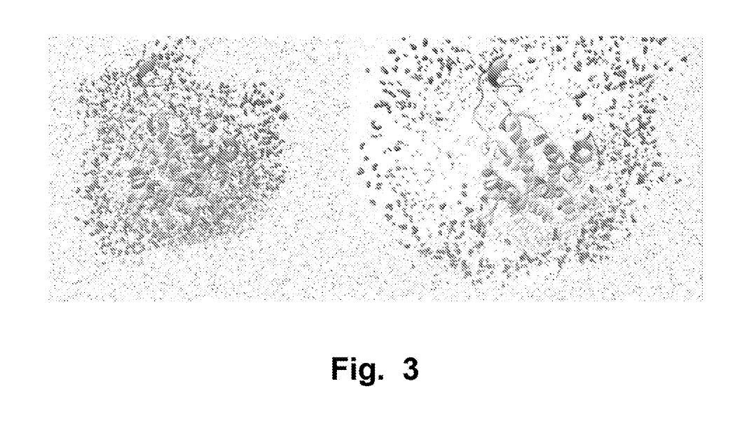

FIG. 3 shows the effect of the dehydration bias obtained by the novel collective variable.

The novel electrostatics-inspired collective variable has been applied in an adaptive steered-MD protocol to study mainly protein-ligand and protein-peptide binding in different pharmacologically relevant classes of target proteins.

The new methodology has been dubbed MD-Dock (i.e. MD-based docking prediction) and allows for running fully flexible docking simulation in explicit solvent.

### Electrostatically Inspired Biasing Potential

The present method describes an external potential energy term, which is summed to the potential energy of a molecular system in a Molecular Dynamics (MD) simulation. This method requires that one or more pairs (A and B, C and D, etc.) of portions of the whole molecular system have been defined. Then, the following steps have to be performed:
1. Fictitious charges are assigned to the atoms of the various subsystems (Qₐ, a∈A, Q_{b}, b∈B etc.). These charges are positioned at the atom centers, as the regular partial charges assigned by the MD force field are.
   a) In the preferred configuration all the charges on a single subset (i.e. A) have the same sign, which is opposite to the sign of the charge assigned to the interacting counterpart (i.e. B). More complex assignments can be however envisioned, to create desired effects.
2. A set of additive potential energy terms is constructed, having a functional form resembling that of a possibly modulated electrostatic interaction. These terms have the following form:

$${C}_{1} {\sum }_{a ∈ A , b ∈ B} \frac{{Q}_{a} {Q}_{b}}{{r}_{a , b}} d ( {r}_{a , b} , {λ}_{1} ) + {C}_{2} {\sum }_{c ∈ C , d ∈ D} \frac{{Q}_{c} {Q}_{d}}{{r}_{c , d}} d ( {r}_{c , d} , {λ}_{2} ) + … ,$$

where the multiplicative constants C modulate the amplitude of the various terms, r are the interatomic distances, d(r, λ) is a function that modulates the effect of the electrostatic-like potential term according to the distance r, and λᵢ parameters rule the spatial range of the modulation.
a) In a preferred embodiment the modulating function assumes the following form:

$${r}^{n} exp ( \frac{- r}{λ} )$$

where n is an integer, and n≥0
and preferably it assumes the form of an exponential decay function

$$exp ( \frac{- r}{λ} ) ,$$

reminiscent of the Yukawa screening.
3. The analytical expression of the gradient of the additive potential energy terms with respect to atomic positions is used to calculate the forces that are added to the regular forces that rule the molecular dynamics of the system.
   a) In the preferred configuration, the C coefficients are updated along the dynamics in a way that the modulus of the overall additive force acting on one subsystem, e.g. A, amounts to a predefined fraction of the modulus of the overall force originated by the gradient of the regular potential energy of the system.
   b) In the preferred configuration, the C coefficients are also updated along the dynamics so as that when the two members of a pair become closer than a predefined threshold, the corresponding additive term gradually switches off.
4. The overall force obtained as described in points 1 to 3 is added to the overall forces felt by the atoms of the system in the Molecular Dynamics engine.

The most significant value of the presented form of biasing potential becomes evident in the case when the subsets A and B represent a protein binding site and a ligand, respectively. By keeping the same sign, as stated in the preferential form, in all the fictitious charges of the same subset, the force field lines “by design” identify a path for entrance into the binding site that the ligand can follow. This path automatically and dynamically updates as the binding site changes its shape along its natural conformational evolution thanks to the laws of electrostatics, which state that the electric field lines start from positive charges (field sources) and end in negative charges (drains) only. Moreover, spreading the attraction or repulsion over the all the atoms of the subsets increases a synergistic motion and reduces the likelihood of occurrence of conformations that are not compatible with the binding due to steric hindrance.

### MD-Docking

As summarized in FIG. 1, the MD-Dock methodology follows a four-stage procedure which includes at step 100 identification of the binding site and definition of the main residues of the receptor in the apo form, at step 200 random initialization of the orientation of a fully solvated ligand in front of the binding site entrance, energy minimization and short unbiased molecular dynamics equilibration of the whole system, at step 300 biased molecular dynamics simulations and at step 400 scoring of the decoy structures.

The whole procedure can be repeated several times to gain statistics (usually not less than 10 times).

In the first step 100 of the approach, MD-Dock, exploiting the NanoShaper tool, analyzes the target protein in order to identify all the possible pockets. Then the pocket corresponding to the binding site is chosen and NanoShaper is used to return the residues that compose it. Based on biochemical and/or biophysical data, and for validation purpose of the method, only the native binding site is targeted here, but in principle any pocket can undergo this approach. Preferentially, the ligand heavy atoms constitute the set B, whereas the main chain atoms, namely N, C, O and CA, of the binding site residues are included in the set A. Notably, the MD-Dock procedure does not require any information about the orientation and the possible interactions between the receptor and the ligand, but only a, possibly approximate, list of the binding site residues.

In the second step 200, NanoShaper is used to find all the possible entrances to the given pocket and to position a set of dots on each of them. These dots, and their normal to the corresponding entrance are then clustered in a set of main gates (N clusters). The centroid of each gate (i.e. the representative of the corresponding cluster) identifies a possible access of the ligand to the pocket. Consistently, a ligand is positioned 10 Å away from each entrance along the normal to the latter, with random orientation. In case of ligand-protein overlap, the ligand is translated farther away from the protein until no clash is present. Therefore, if the dots on the entrances of the pocket group in N clusters (i.e. N possible accesses), the algorithm chooses N different ligand positions as starting points for each of N MD-Dock simulations for each entrance. During the final part of the second stage, the target-ligand system is solvated in the simulation box. Adding a suitable number of counter-ions neutralizes the overall system. Then, the whole system undergoes energy minimization. Three different consecutive 100 ps long MD runs are performed: 1) both the protein and ligand are restrained (1000 kJ/mol nm̂2), 2) the protein is free while the ligand restrained and 3) both the protein and the ligand are free. The coordinate output from the last simulation is then used as input for the flexible docking.

The third step 300 consists of an adaptive simulation incorporating a biased attraction between groups A and B. The protocol is adaptive in two different ways. First, the biasing force is always kept below a user-defined threshold. More specifically, in the present case every 0.2 ps of simulation, the average modulus of the resulting force acting on the ligand is calculated as well as that of the bias and a scaling factor is applied to the latter so that it is a given fraction of the former. This is done to avoid a too strong biasing that could distort the structure of the system and to reduce the probability of following high-energy binding paths. Second, the bias is further reduced based on the distance between the ligand B and a subset A of A, composed by atoms that are supposed (or guessed, or known) to interact with the ligand. This option aims at identifying the final steps of the binding, through the decrease of the above-mentioned distance, and at making the bias in this phase particularly unobtrusive, so as that the simulation becomes closer to unbiased MD. The switch off is obtained via a scaling pre-factor γ, which is multiplied times the biasing force. This factor is calculated via a switching function as follows:

$$γ = \frac{1}{1 + exp ( - ss * ( dist - th ) )}$$

where ss and th are two suitable parameters. The value of dist can be evaluated in two alternative ways:

dist₁=min_{y∈Ã}min_{x∈B}ds(x,y);

dist₂=max_{y∈Ã}min_{x∈B}ds(x,y);

where ds(x,y) is the pairwise distance between the two atoms x and y.

The bias is switched off either as soon as any atom of the ligand falls below a predefined distance from any atom belonging to Ã⊂A (dist₁ definition) or if for all of the atoms belonging to A the closest atom of set B falls below that threshold (dist₂ definition). The choice of the specific option of the method depends mainly on the confidence the user has on the validity of his assumptions on the interaction. Definition 1 is used when the level of confidence is lower and therefore the MD-Dock basically drives the ligand into the binding site (“blind sampling”). In contrast, definition 2 can be exploited when one wants to push the ligand to interact with specific residues with a higher degree of confidence. This approach can be particularly suited when one wants to investigate certain fragments and their interactions against a predefined subset of the residue binding pockets.

The fourth and last step 400 is aimed at scoring the final poses obtained in the performed replicas. In order to discriminate the best pose, the same collective variable is exploited but in a reverse protocol, i.e. forcing the undocking. For each pose obtained from the MD-Dock simulation a 2 ns of undocking steered molecular dynamics has been carried out on the collective variable, reducing its initial value of 50%. Using the steering work seen during the undocking process it is chosen the best pose as the one that needs the highest work. In case of ambiguity, a further discrimination can be done using the protein-ligand intermolecular energy.

In order to challenge the ability of this approach, three different cases of MDD (MD-Dock) shown in Table 1 have been selected, i.e. two protein-ligand cases, including Acetylcholinesterase (hydrolase), Cyclin-dependent kinase 2 (kinase) and one protein-peptide case, namely RAD51 in complex with BRC repeat of BRCA2.

All simulations have been run starting from the apo conformation of the targets. As mentioned above, the inventors a priori assumed to know which was the set of amino acids defining the binding pocket. The heavy atoms of some of those residues, together with those of the ligand, were utilized to monitor the RMSD (compared to the crystal structure) evolution vs. the simulation time.

MD-Docking results are summarized in the Table 1.

| | | | | best replica | simulated |
|---|---|---|---|---|---|
| | | | | RMSD | time |
| Dataset | Protein | Ligand | PDB ID | (Å) | (ns) |
| MDD1 | AChE | Donepezil | 4EY7 | 1.8 | 7 |
| MDD2 | CDK2 | Staurosporine | 4ERW | 1.7 | 9 |
| MDD3 | RAD51 | BRCA2 | 1N0W | 0.7 | 4 |

Finally, the inventors have used the same collective variable in a slightly different procedure, but always in the context of protein-ligand interaction. The dehydration of a binding site by means of an electrostatic-like repulsive term has been forced, and the observed reluctance of individual water molecules to exit the binding site has been used as an indication of their energetic stability. This information, sometimes dubbed “happiness”, is emerging as relevant in the field of drug design, especially in the so-called “hit-to-lead” phase.

MDD1: Acetylcholinesterase (AChE) in Complex with Donepezil

The MDD1 dataset was composed of acetylcholinesterase (AChE) in complex with donepezil drug. In the last two decades, inhibition of acetylcholinesterase, a serine hydrolase that plays a key role in inhibiting the nervous signal, is one of the most successful strategies in the reinforcement of the cholinergic transmission, leading to the development of a number of drugs currently in clinical use for the treatment of Alzheimer's disease. Differences in the binding of ligands that span the length of the AChE gorge have been documented and the cause of such differences is likely attributed to subtle changes in the gorge shape. In particular, the interaction with Y337, which has been described as a “swinging gate” is critical for the inhibition of the enzyme. Actually, crossing the plane composed by Y124 and Y337 represents the transition state of the gorge penetration. Interestingly, in the apo form the gate is closed and it remained stable during simulations. The main difference in drug activity consists in the possibility to break the Y124/Y337 plane. Donepezil ligand can bind AChE only when Y337 moves opening the gate of the AChE gorge.

The inventors therefore performed MD-Docking simulations, by which the ligand is docked into the apo form of the enzyme. The simulations occurred via the encounter complex with W286 of the peripheral anionic site (PAS). Donepezil reached the binding pocket in 7-8 ns with a RMSD of 1.6 Å with respect to the X-ray structure. The simulations are repeated 10 times in order to perform a statistical analysis. One possible attempt to discriminate the best pose is to identify the highest work value during the undocking simulations. Results are shown in FIG. 2.

MDD2: Cyclin-Dependent Kinase 2 (CDK2) in Complex with Staurosporine

Protein kinases are an important new class of targets for specific pharmacological inhibition in therapy, especially for cancers. Among all, Cyclin-dependent kinases (CDKs) are members of the serine/threonine kinase family and are key enzymes in cell-cycle progression and transcription. Deregulation of CDKs has been implicated in a number of diseases such as inflammation, neurodegenerative diseases and cancer. The CDK2-cyclin A complex predominantly controls the G1- to S-phase checkpoint and therefore represents an attractive target for therapeutics designed to arrest or recover control of the cell cycle in aberrantly dividing cells. Staurosporine, one of the CDK2 inhibitors, directly compete with ATP for binding to the active site.

During the simulations, the inventors noticed that the apo form of CDK2 often rearrange the side chains of the CDK2 binding site, in which the LYS33 occludes the entrance of a ligand. Only when this LYS33 shift its side chain outward of the binding site, the ligand can enter and recapitulate the main interactions with CDK2. Interestingly, this LYS33, located between the ATP binding site and the allosteric pocket, is the same residue involved in the interaction with the 8-anilino-1-naphthalene sulfonate (ANS), which binds to a large allosteric pocket adjacent to the ATP site. Also in this case the best pose could be discriminated by presenting one of the highest work profiles calculated during the undocking simulations.

MDD3: RAD51 Protein in Complex with the BRCA2 BRC Repeat

The possibility to study protein-protein and protein-peptide systems plays a key role in the characterization of protein-protein inhibitors. RAD51-BRCA2 BRC repeat complex has been chosen since it could represent an important cancer target. RAD51 is a 339-amino acid protein that plays a major role in homologous recombination of DNA during double strand break repair. This protein is also found to interact with BRCA2, which may be important for the cellular response to DNA damage. In fact, the BRCA2-RAD51 interaction is essential for the DNA repair. In cancer cells, if this interaction is disrupted, the cell will become hypersensitive to DNA damage agent treatment. Therefore, this interaction may provide an ideal target for developing novel specific anti-cancer drugs.

The docking simulations have been carried out keeping restrained the secondary structure of the BRCA2 BRC repeat in order to avoid the unfolding of the small peptide. The restraints used are the hydrogen bond between the NH and CO in the alpha helix. The final pose is determined in 4 ns with 0.7 RMSD with respect to the crystallographic structure.

### Probing the Hydration of a Binding Site: The A2A GPCR Case

GPCRs represent one of the most important target classes in pharmaceutical research. Among them, adenosine receptors represent promising therapeutic targets for CNS diseases, cerebral and cardiac ischemic diseases, cancer, and immunological and inflammatory disorders. The importance of water for G protein-coupled receptors has been supported by recent crystallographic data from different studies showing how ordered waters interact with residues that are important in disease states, receptor activation, and signaling. In this context, several works have been presented by researchers at Heptares Therapeutics (A. Bortolato, B. G. Tehan, M. S. Bodnarchuk, J. W. Essex, and J. S. Mason, J. Chem. Inf. Model. 2013, 53, 1700-1713), comparing different existing approaches to identify most stable water positions of the binding site in both apo and holo forms and to estimate the corresponding free energy difference from bulk waters.

Along the same lines, here, the invention exploits the new collective variable in a specific protocol where a short-ranged repulsion between the atoms of the binding site (and of the ligand in the holo situation) and water molecules is exerted. Then, the reluctance of the water molecules to leave the binding site due to the biasing force is used for the same purpose. In order to do that, set A is composed of all the heavy atoms of the binding site (and by those of any possible ligand). In contrast, set B is composed by the water oxygen atoms of the system. Fictitious charges on the water molecules have the same sign and have opposite sign with respect to that borne by the atoms of the binding site (i.e. Qₐ·Q_{b}<0, Qₐ·Qₐ>0, Q_{b}·Q_{b}>0 ∀a∈A and ∀b∈B}. Lambda is chosen so as that only water molecules in and surrounding the binding site are subjected to the bias.

The analyzed systems were built from the structure having the pdb code 3UZC, after removing or replacing the ligand and modeling the extracellular loop based on that of the high-resolution structure 4EIY. Residues of the binding site have been chosen with the help of the pocket identification functionality of the NanoShaper software (S. Decherchi and W. Rocchia, PLoS ONE 8(4): e59744, 2013), by selecting the residues of the pocket which corresponded to the binding site. First, it has been tested that the bias was actually able to dehydrate the pocket, which turned out to be promptly feasible, as shown in FIG. 3.

A full dehydration of the site as that shown in FIG. 3 is not needed in a more subtle analysis. In the following simulations the initial value of the collective variable was estimated during equilibration and an initial production phase of 25 ps. Then, that value was decreased of 50% in 50 ps, and finally maintained for 200 ps. This corresponded to the application of a dehydrating bias followed by a short relaxation, respectively. The water occupancy map was then calculated and the regions containing more persistent water molecules were identified.

This analysis has been performed on three different holo structures, that are named 4a, 4e and 4f. As a result, in all of the simulations the same two hydration sites as shown by Bortolato et al. (A. Bortolato, B. G. Tehan, M. S. Bodnarchuk, J. W. Essex, and J. S. Mason, J. Chem. Inf. Model. 2013, 53, 1700-1713) have been observed, which presented persistent water molecules throughout the simulation. These water molecules have been analyzed in more details, trying to identify how much of their persistence was due to steric hindrance, i.e. a kinetic trap. In order to do this, the NanoShaper software has been used on each frame of the 200 ps plateau, after stripping all explicit water molecules. NanoShaper was asked then to build the Connolly surface and remove all internal cavities. Then the centers of the persistent waters were observed, to see whether they occurred outside or inside the Connolly surface, indicating accessibility or inaccessibility to the external water reservoir, respectively.

It shall be clear that the embodiments and implementation details may widely vary compared to what has been described and illustrated by way of non-limiting example only, without departing from the scope of the invention as defined by the appended claims.

1. A method for enhancing the simulation of the interaction between at least a first and a second molecular system, said interaction resulting from actual attraction and repulsion forces between said at least a first and a second molecular system, characterised in that it comprises applying an additional virtual electrostatic force between said at least a first and a second molecular system.

2. The method according to claim 1, wherein said additional virtual electrostatic force is applied between a first selected plurality of atoms of said first molecular system and a second selected plurality of atoms of said second molecular system.

3. The method according to claim 2, wherein said additional virtual electrostatic force is applied between each atom of said first selected plurality of atoms and each atom of said second selected plurality of atoms.

4. The method according to claim 3, wherein said additional virtual electrostatic force is not applied between the atoms of said first selected plurality of atoms, nor between the atoms of said second selected plurality of atoms.

5. The method according to claim 1, wherein said additional virtual electrostatic force has a functional form of the type of a modulated electrostatic interaction.

6. The method according to claim 1, wherein said additional virtual electrostatic force is scaled so as to amount to a predefined fraction of the overall actual attraction and repulsion forces.

7. The method according to claim 5, wherein said additional virtual electrostatic force has a functional form of the type
$${C}_{1} {\sum }_{a ∈ A , b ∈ B} \frac{{Q}_{a} {Q}_{b}}{{r}_{a , b}} d ( {r}_{a , b} , λ )$$
where A and B are said first and second molecular system, a and b are the respective atoms of said first and second selected plurality of atoms, r_{a,b} is the interatomic distance between each atom of said first selected plurality of atoms and each atom of said second selected plurality of atoms, C is a modulation parameter and d(r, λ) is a spatially modulating function where A is a decay parameter.

8. The method according to claim 7, wherein said additional virtual electrostatic force is scaled so as to decrease when the distance between an atom of said first selected plurality of atoms and an atom of said second selected plurality of atoms is lower than a predetermined threshold.

9. The method according to claim 8, wherein the spatially modulating function has the functional form of
$${r}^{n} exp ( \frac{- r}{λ} ) ,$$
where n is an integer, and n≥0.

10. The method according to claim 9, wherein n=0.

11. The method according to claim 1, wherein said first molecular system is at least a portion of a binding site of a protein and said second molecular system is at least a portion of a ligand.

12. The method according to claim 11, wherein said ligand is a drug candidate.
